(19) United States
(12) Patent Application Publication
(10) Pub. No.: US 2023/0278862 A1
(43) Pub. Date: Sep. 7, 2023

(54) SYNTHESIS METHOD OF HEXAFLUOROPHOSPHATE

(71) Applicants: Zhejiang Zhongxin Fluoride Materials Co., Ltd., Shaoxing (CN); Fujian Zhongxin Fluoride Material Global Technology Co., Ltd., Sanming (CN)

(72) Inventors: Qiliang YUAN, Shaoxing (CN); Jian CHEN, Shaoxing (CN); Haifeng CHEN, Shaoxing (CN); Pengfei XU, Shaoxing (CN); Jianfei ZHU, Shaoxing (CN); Dongdong JIANG, Shaoxing (CN); Yinhao CHEN, Shaoxing (CN); Chao WANG, Shaoxing (CN)

(21) Appl. No.: 18/316,354

(22) Filed: May 12, 2023

Related U.S. Application Data
(63) Continuation of application No. PCT/CN2022/137757, filed on Dec. 9, 2022.

(30) Foreign Application Priority Data
Dec. 24, 2021 (CN) 202111600015.8

(51) Int. Cl. C01B 25/455

(52) U.S. Cl. CPC C01B 25/455

(57) ABSTRACT

The disclosure discloses a synthesis method of hexafluorophosphate, belonging to the technical field of chemical synthesis. The synthesis method of hexafluorophosphate is characterized by comprising the following steps: reacting a phosphorus pentahalide inert solvent solution obtained by dissolving phosphorus pentahalide into an inert solvent with an alkali metal fluoride salt hydrogen fluoride solution obtained by dissolving an alkali metal halide salt into anhydrous hydrogen fluoride in a reactor in a ratio to obtain a mixture consisting of hexafluorophosphate, hydrogen fluoride, the inert solvent and hydrogen halide, performing gas-liquid separation to remove a hydrogen halide gas, then heating and evaporating to recover hydrogen fluoride, finally performing solid-liquid separation to recover the inert solvent, and then drying the solid to obtain hexafluorophosphate. The synthesis method of the disclosure has the advantages of simple operation, good safety, high reaction yield, excellent product quality and the like, and can achieve continuous production.

### CROSS-REFERENCE TO RELATED APPLICATIONS

This application is a continuation of International Patent Application No. PCT/CN2022/137757 with a filing date of Dec. 9, 2022, designating the United States, now pending, and further claims priority to Chinese Patent Application No. 202111600015.8 with a filing date of Dec. 24, 2021. The content of the aforementioned applications, including any intervening amendments thereto, are incorporated herein by reference.

### TECHNICAL FIELD

The disclosure belongs to the technical field of chemical synthesis, and particularly relates to a synthesis method of hexafluorophosphate.

### BACKGROUND OF THE PRESENT INVENTION

Global warming is a major issue for human in the 21st century, which not only is related to human development, but also affects human survival. To solve the global warming issue, first, traditional high-pollution high-emission petrifaction energies are replaced with novel clean energies such as solar energy and wind energy so as to reduce the generation of greenhouse gases such as carbon dioxide. Therefore, development of green and environmental-friendly secondary batteries is a key to solve the issue. After more than half a century of research and industrial development, the current lithium-ion batteries have been produced on large scale and are widely applied in the aspects of energy storage and power. Sodium ion batteries have undergone fast development and gradually entered the application stage. At the same time, researches on potassium ion batteries are increasingly receiving attentions.

Hexafluorophosphate is the most common electrolyte in the current secondary batteries, wherein lithium hexafluorophosphate is widely applied to production of lithium ion batteries, sodium hexafluorophosphate is applied to production of sodium ion batteries, and potassium hexafluorophosphate is applied to preparation of lithium hexafluorophosphate and sodium hexafluorophosphate besides research and production of potassium ion batteries.

According to different used raw materials and different key intermediates, the synthesis methods of hexafluorophosphate include a hexafluorophosphate ion exchange method, a fluorophosphoric acid method and a phosphorus pentafluoride method.

(1) Hexafluorophosphate ion exchange method

M′PF₆+MX→MPF₆

X=F,Cl

M=Li,Na,K

M′=Li,Na,K,NH₄⁺

(2) Fluorophosphoric acid method

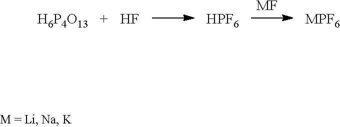

(3) Phosphorus pentafluoride method

PF₅+MF→MPF₆

PF₅+MCl+HF→MPF₆

M=Li,Na,K

In the above synthesis methods of hexafluorophosphate, none of a phosphorus pentafluoride gas and hydrogen fluoride as a raw material is used during the synthesis in the hexafluorophosphate ion exchange method, and therefore this method is safer and more convenient in production operation. However, using one hexafluorophosphate to prepare another hexafluorophosphate hardly is competitive in term of synthesis cost due to expensive raw material itself. The fluorophosphoric acid method avoids the use of the phosphorus pentafluoride gas, which reduces the synthesis difficulty to a certain extent, but water generated in the reaction process adversely affects the quality of the hexafluorophosphate product and high-pure hexafluorophosphate is difficultly prepared. Although the phosphorus pentafluoride method uses the phosphorus pentafluoride gas, however, this method has the advantages of simple operation, low synthesis cost, high reaction yield, good product quality and the like, and therefore is the most common method for industrial synthesis of hexafluorophosphate.

According to different phosphorus sources, the phosphorus pentafluoride method is divided into an elemental phosphorus method, a phosphoric acid method, a polyphosphoric acid method, a phosphorus trichloride method, a phosphorus pentachloride method, etc.

(i) Elemental phosphorus method:

P+F₂→PF₅

(ii) Phosphoric acid method:

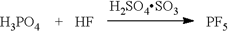

(iii) Polyphosphoric acid method:

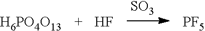

(iv) Phosphorus trichloride method:

PCl₃+Cl₂+HF→PF₅

(v) Phosphorus pentachloride method:

PCl₅+HF→PF₅.

The elemental phosphorus method is that elemental phosphorus (red phosphorus, yellow phosphorus, white phosphorus, etc.) is placed in a special reactor, a fluorine gas is introduced into the reactor, and the above raw materials are subjected to gas-solid reaction to obtain phosphorus pentafluoride. This method has the advantages that the prepared phosphorus pentafluoride has high purity, and high-pure phosphorus pentafluoride is prepared without complicated purifying steps. This method has the disadvantages that an additional process of preparing fluorine via electrolysis is needed, i.e., the fluorine gas is first prepared and the reaction process is gas-solid reaction, the reactor has high requirements on structure and materials, the reaction conditions are relatively harsh, so this method is difficult to industrially apply on large scale. The phosphoric acid method is similar to the polyphosphoric acid method, phosphoric acid or its polymers are used as raw materials to react with hydrogen fluoride to obtain aqueous hexafluorophosphoric acid, and then the aqueous hexafluorophosphoric acid is dehydrated with fuming sulfuric acid or sulfur trioxide to prepare phosphorus pentafluoride. This method is low in synthesis cost, however, use of a large amount of fuming sulfuric acid or sulfur trioxide as a dehydration agent is not friendly to environments, and fuming sulfuric acid or sulfur trioxide contains many impurities, so high-pure phosphorus pentafluoride is difficultly prepared. The phosphorus trichloride method is similar to the phosphorus pentachloride method, where the phosphorus trichloride method is that phosphorus trichloride reacts with a chlorine gas to synthesize phosphorus pentafluoride and then phosphorus pentafluoride reacts with hydrogen fluoride to obtain phosphorus pentafluoride, the phosphorus pentachloride method is that phosphorus pentachloride as a raw material directly reacts with hydrogen fluoride to obtain phosphorus pentafluoride. Compared to the phosphorus trichloride method, the phosphorus pentachloride method is more competitive in terms of synthesis cost, product quality and environmental friendliness because a chlorination reaction step is omitted. Therefore, the phosphorus pentachloride method has become the most common method for industrial preparation of phosphorus pentafluoride.

Phosphorus pentachloride as the raw material reacts with hydrogen fluoride to prepare phosphorus pentafluoride and then phosphorus pentafluoride reacts with a fluoride salt to synthesize hexafluorophosphate, which is currently the most valuable industrial application method for synthesizing hexafluorophosphate. However, this method has many shortages:

(1) a phosphorus pentachloride solid as one of reaction raw materials has a boiling point of up to 180° C. and is highly prone to sublimation, so it is generally fed in a solid form instead of being transformed into a liquid by heating. Another raw material hydrogen fluoride has a boiling point of only 19.5° C. and is extremely strong in volatility, lots of hydrogen fluoride is evaporated by little local heat release or gas release during the reaction, however, phosphorus pentachloride exceptionally violently reacts with hydrogen fluoride, and a solid-liquid reaction occurs at the moment that the two raw materials are in contact, with significant local heat release and release of a large amount of hydrogen chloride gases, leading to the volatilization of a large amount of hydrogen fluoride, thereby not only causing unnecessary loss of hydrogen fluoride and damaging the stability of the reaction system, but also creating safety production accidents due to harbored serious safety hazards. Therefore, how to solve the problem of feeding phosphorus pentachloride and how to alleviate the reaction process of phosphorus pentachloride and hydrogen fluoride are the top issues that need to be solved.

(2) Phosphorus pentafluoride obtained by reaction of phosphorus pentachloride with hydrogen fluoride is a gas which has a low boiling point of only −84.6° C. and is difficult to liquify, so that phosphorus pentafluoride is difficult to purify, store, transport and use, leading to increased synthesis cost and reduced production efficiency. In addition, phosphorus pentafluoride has high activity, is prone to decomposition during the storage, transportation and use, leading to reduced in reaction yield and product purity. Therefore, how to solve the problems of storage, transportation and use of phosphorus pentafluoride, and strive to produce and use it at any time as much as possible and even achieve in-situ synthesis and use is an important issue that needs to be solved.

(3) The raw materials used for synthesis of hexafluorophosphate are large in toxicity and high in hazard, the reaction process has serious safety risk, however, at present, batch reaction is generally used to synthesize hexafluorophosphate, with serious potential production safety hazard. Therefore, how to continuously modify the existing hexafluorophosphate synthesis process and reduce the production safety risk is an issue that is urgently solved.

Therefore, there are still a lot of optimization works to think and research for synthesis processes of hexafluorophosphate.

### SUMMARY OF PRESENT INVENTION

For the shortages in the existing hexafluorophosphate synthesis process, the disclosure provides a synthesis method of hexafluorophosphate, which is safe, reliable and suitable for industrial application, and has the advantages of simple operation, good safety, high reaction yield, excellent product quality, continuous production and the like.

The disclosure adopts the following technical solution:

Provided is a synthesis method of hexafluorophosphate, comprising the following steps:

(1) dissolving phosphorus pentahalide into an inert solvent to obtain a phosphorus pentahalide inert solvent solution (I);

(2) dissolving an alkali metal halide salt into anhydrous hydrogen fluoride to obtain an alkali metal fluoride salt hydrogen fluoride solution (II);

(3) reacting the phosphorus pentahalide inert solvent solution (I) and the alkali metal fluoride salt hydrogen fluoride solution (II) in a reactor in a ratio to obtain a mixture (III) consisting of hexafluorophosphate, hydrogen fluoride, the inert solvent and hydrogen halide;

(4) performing gas-liquid separation on the mixture (III) obtained in step (3) to separate out a hydrogen halide gas and obtain a mixture (IV) consisting of hexafluorophosphate, hydrogen fluoride and the inert solvent;

(5) removing hydrogen fluoride from the mixture (IV) obtained in step (4) to obtain a mixture (V) consisting of hexafluorophosphate and the inert solvent; and

(6) performing solid-liquid separation on the mixture obtained in step (5), and drying to obtain hexafluorophosphate.

The synthesis route adopted in the disclosure can be represented by the following reaction formula:

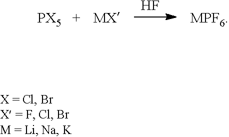

The further setting of the disclosure is as follows:

in step (1),

the phosphorus pentahalide is selected from one or two of phosphorus pentachloride and phosphorus pentabromide. The selection of types of phosphorus pentachlorides is not directly related to the types of synthesized hexafluorophosphates, that is to say, regardless of phosphorus pentachloride or phosphorus pentabromide or a mixture of them, they are all used for synthesis of any one of lithium hexafluorophosphate, sodium hexafluorophosphate and potassium hexafluorophosphate. The phosphorus pentahalide is preferably any one of phosphorus pentachloride and phosphorus pentabromide, their mixture is not suggested to be used. As such, the hydrogen halide gas generated in the subsequent reaction process is single hydrogen halide, i.e., hydrogen chloride or hydrogen bromide, thereby avoiding the generation of a mixture of hydrogen chloride and hydrogen bromide. After being absorbed with water, a hydrogen chloride or hydrogen bromide solution can be co-produced, with a higher recycling value.

The inert solvent is not only required to have good solubility for phosphorus pentahalide, but also is required not to generate any side reactions with raw materials, intermediates, products and the like. The inert solvent can be an alkane solvent, a halogenated alkane solvent, an aromatic solvent, a halogenated aromatic solvent, etc., or a single solvent or a mixed solvent consisting of two or more solvents. The alkane solvents are C4-C10 linear, branched or cyclic alkanes, the representative alkane solvents include n-pentane, n-hexane, cyclohexane, n-heptane, methylcyclohexane and the like. The halogenated alkane solvents are represented by the following general formula:

CₙH₍₂ₙ₊₂₋ₘ₎Xₘ

wherein X=F, Cl and Br, n=1-10, m=1-4, the carbon chain of halogenated alkane can be straight, branched or cyclic, and the representative halogenated alkanes include dichloromethane, trichloromethane, carbon tetrachloride, dichloroethane, bromoethane, dibromoethane and the like. The aromatic solvents can be represented by the following general formula:

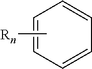

wherein substituent group R is H and a C1-C6 straight, branched or cyclic alkyl substituent group, n=0-6, when multiple alkyl substituent groups are present in a phenyl ring, the alkyl substituent groups are the same or different, and the representative aromatic solvents include benzene, toluene, xylene, trimethylbenzene, ethylbenzene, methylethylbenzene and the like. The halogenated aromatic solvents can be represented by the following general formula:

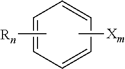

wherein substituent group R is H and a C1-C6 straight, branched or cyclic alkyl substituent group, n=0-6, substituent group X=F, Cl and Br, m=0-6 and n+m≤6, when multiple alkyl and halogen atom substitutions are present in the phenyl ring, substituted alkyl and halogen atoms are the same or different, and the representative halogenated aromatic solvents include fluorobenzene, chlorobenzene, bromobenzene, difluorobenzene, dichlorobenzene, p-chlorofluorobenzene, p-fluorotoluene and the like. The amount of the inert solvent is as 1-20 times as the mass of phosphorus pentahalide.

It is noted that, solvents containing atoms such as nitrogen and oxygen, for example nitrile solvents such as acetonitrile, ester solvents such as dimethyl carbonate, ether solvents such as ethylene glycol dimethyl ether, and ketone solvents such as ethanone, have good solubility for phosphorus pentahalide, however, during the reaction, these solvents are prone to decomposition and complexation or other side reactions with hydrogen fluoride, phosphorus pentafluoride and hexafluorophosphate, leading to facts that the color of the reaction solution darkens, the appearance and purity of the product deteriorate, the reaction yield decreases, the solvent recovery rate decreases, and the solvents are difficult to recycle. Therefore, such the solvents are not suitable for use as reaction solvents.

To shorten the dissolution process of phosphorus pentahalide and the inert solvent, a heating method can be used to increase the dissolution speed of phosphorus pentahalide in the inert solvent, and then after phosphorus pentahalide is completely dissolved, the temperature is reduced to a required temperature on the promise of ensuring that the phosphorus pentahalide solid is not precipitated out after phosphorus pentahalide is completely dissolved, and then the above mixed solution was transferred to the reactor for reaction. Considering that introduction of water can adversely affect the quality of the final product, airtight and dry inert gas protection and other manners should be adopted in the feeding and dissolving processes of phosphorus pentahalide to isolate environmental water vapor.

Phosphorus pentahalide is first dissolved into the inert solvent to obtain a phosphorus pentahalide inert solvent solution followed by subsequent reaction. Such the operation scheme is of great significance for the smooth implementation of the process. Phosphorus pentahalide, regardless of phosphorus pentachloride or phosphorus pentabromide, is a sublimation solid, where the boiling point of the phosphorus pentachloride solid is up to 180° C., the phosphorus pentabromide solid has no definite boiling point and is decomposed after the temperature is higher than 100° C., and therefore the stable physical states of phosphorus pentachloride and phosphorus pentabromide are solid states, it is difficult to stably maintain phosphorus pentachloride and phosphorus pentabromide to be in liquid and gaseous forms. If phosphorus pentahalide is fed in a solid form, it is suitable for batch reactors, but the feed speed cannot be precisely controlled. In addition, the solid-liquid reaction occurs at the moment that the phosphorus pentahalide solid is in contact with hydrogen fluoride, with significant local heat release and release of lots of hydrogen halide gases, which not only leads to volatilization of lots of materials and gas entrainment loss but also has serious potential safety hazards and is extremely prone to safety production accidents. In other words, phosphorus pentahalide attempts to use gaseous feed. Due to its unique physicochemical properties, the gas can be easily condensed into a solid so as to block the feed pipeline and affect the smoothness of the reaction process. At the same time, it is difficult to accurately measure and feed gaseous materials according to requirements. Inaccurate measurement is acceptable for batch reactor reactions, but for continuous flow reactions, instantaneous feed control accuracy is required to be extremely high, thus it is not possible to meet the requirements of the continuous flow reaction process. In addition, continuous flow reactors are usually pressurized reactors, and gaseous materials can only enter the reactor smoothly when they have a pressure higher than the internal pressure of the reactor. Therefore, the gaseous feed of phosphorus pentahalide not only cannot meet the process requirements, but also is difficult to achieve in industry.

in step (2),

the alkali metal halide salt is represented by the following general formula:

MX

M=Li, Na, K

X=F, Cl, Br

When the synthesized target product is lithium hexafluorophosphate, the alkali metal halide salt is selected from one or more of lithium fluoride, lithium chloride and lithium bromide; when the synthesized product is sodium hexafluorophosphate, the alkali metal halide salt is selected from one or more of sodium fluoride, sodium chloride and sodium bromide; when the synthesized product is potassium hexafluorophosphate, the alkali metal halide salt is selected from one or more of potassium fluoride, potassium chloride and potassium bromide.

When the alkali metal halide salt is an alkali metal fluoride salt, an process that the alkali metal fluoride salt is dissolved into anhydrous hydrogen fluoride is a pure dissolution process, with unapparent dissolution heat release and no gas generation and mild dissolution process; when the alkali metal halide salt is an alkali metal chloride salt and an alkali metal bromide salt, the process that the alkali metal halide salt is dissolved into anhydrous hydrogen fluoride is not only a dissolution process but also a reaction process for halogen exchange, and a reaction equation is as follows:

MX+HF→MF+HX

X=Cl,Br,

The alkali metal chloride salt and the alkali metal bromide salt are dissolved into anhydrous hydrogen fluoride to generate alkali metal fluoride salt while generating a molecule of hydrogen halide gas. When the alkali metal chloride salt is used, the generated hydrogen hydride gas is hydrogen chloride; when the alkali metal bromide salt is used, the generated hydrogen hydride gas is hydrogen bromide. The alkali metal halide salt is preferably a single halogen compound, especially when the alkali metal halide salts are a chloride salt and a bromide salt, the hydrogen halide gas generated in the dissolving process is single hydrogen halide, i.e., hydrogen chloride or hydrogen bromide, the generation of a mixture of hydrogen chloride and hydrogen bromide is avoided, a hydrogen chloride or hydrogen bromide solution can be co-produced after absorption with water, with a higher recycling value. The process of dissolving the alkali metal chloride salt and the alkali metal bromide salt into anhydrous hydrogen fluoride involves halogen exchange reaction, i.e., one molecule of hydrogen halide is generated, however, the reaction process is relatively mild and little in released heat, and can be controlled by adjusting the feeding ratio, with high safety.

To further improve the synthesis efficiency and economic benefits of hexafluorophosphate, when the alkali metal halide salt used in step (2) is the alkali metal chloride salt or the alkali metal bromide salt, phosphorus pentahalide used in step (1) corresponds to phosphorus pentachloride or phosphorus pentabromide, i.e., when the alkali metal chloride salt is used in step (2), phosphorus pentachloride is used in step (1), and when the alkali metal bromide salt is used in step (2), phosphorus pentabromide is used in step (1). As such, step (2) and step (4) can share the hydrogen halide treatment system, which can not only avoid the repeated building of the production device to reduce the operation cost of equipment, but also effectively avoid the generation of mixed hydrogen halide and promote the economic value of the co-produced hydrogen halide solution.

It is especially noted that, the alkali metal halide salt is a preferred alkali metal source because only hydrogen halide gas is generated in the process of dissolving the alkali metal halide salt into anhydrous hydrogen fluoride and subsequent reaction process without introduction of water, however, water is generated in the process of dissolving other alkali metal sources such as alkali metal carbonate, alkali metal bicarbonate and alkali metal hydroxide into anhydrous hydrogen fluoride, the water introduced into the reaction system will lead to decomposition of the product hexafluorophosphate to generate fluorophosphates so as to create adverse effects on the quality of the final product, and therefore the other alkali metal sources cannot be used as alkali metal sources of the disclosure.

The anhydrous hydrogen fluoride is liquid hydrogen fluoride. In light of hydrogen fluoride having a boiling point of 19.5° C., to ensure hydrogen fluoride being in a liquid state, the temperature of the system must be less than 19.5° C. in the dissolving process and alkali metal fluoride salt hydrogen fluoride solution storage process, the preferred dissolving and storing temperature is −40 to 19° C. The amount of anhydrous hydrogen fluoride is as 1-20 times as the mass of the alkali metal halide salt.

Considering that introduction of water will create adverse effects on the quality of the final product, airtight and dry inert gas protection and other manners should be adopted in the feeding and dissolving processes of phosphorus pentahalide to isolate environmental water vapor.

in step (3),

after the phosphorus pentahalide inert solvent solution (I) and the alkali metal fluoride salt hydrogen fluoride solution (II) are added into a reactor in a ratio, phosphorus pentahalide first reacts with hydrogen fluoride to generate phosphorus pentafluoride, and the generated phosphorus pentafluoride reacts with the alkali metal fluoride salt in situ to generate hexafluorophosphate. The in-situ generation and reaction of phosphorus pentafluoride avoid the separation, purification, storage, transportation and other operations of phosphorus pentafluoride, thereby effectively simplifying the production process, promoting the utilization rate of phosphorus pentafluoride, improving the production efficiency and reducing the synthesis cost.

The reactor can be a batch reactor, a tubular reactor and a microreactor, preferably the tubular reactor and the microreactor, more preferably the microreactor. The use of the microreactor can effectively promote the yield of the reaction and the purity of the product, simplify the reaction operation and improve the safety of the reaction for the reasons that (1) phosphorus pentahalide reacts with hydrogen fluoride to synthesize phosphorus pentafluoride, such the reaction is very intense and releases a large amount of heat. Although phosphorus pentahalide is dissolved into an inert solvent and fed in a solution state to avoid more intense solid-liquid reaction processes, the reaction intensity is further controlled by controlling the feeding rate, allowing the reaction to occur in both the batch reactor and the tubular reactor, the microreactor has better mixing efficiency and higher heat transfer area compared to the batch reactor and the tubular reactor, which is more conducive to controlling the reaction under milder conditions. (2) In the process of synthesizing phosphorus pentafluoride by reacting phosphorus pentahalide with hydrogen fluoride, five molecules of hydrogen halide gases are generated. At the same time, the inert solvent used to dissolve phosphorus pentahalide is also insoluble with hydrogen fluoride. Therefore, in the reaction process, there is actually a gas-liquid-liquid heterogeneous reaction, and a better mixing effect will inevitably bring better reaction results. For the mixing effect, the microreactors have unique advantages compared to the batch reactor and the tubular reactor. (3) Due to the particularity of the reaction, a large amount of heat is locally released at the moment that phosphorus pentahalide is in contact with hydrogen fluoride, and five molecules of hydrogen halide gases are generated during the reaction. Furthermore, the intermediate product phosphorus pentafluoride is a gas, and hydrogen fluoride has a low boiling point and is easy to volatilize, so if the batch reactor is adopted, a part of the intermediate product phosphorus pentafluoride is consumed by being entrained out of the reaction by the hydrogen halide gas and the volatilized hydrogen fluoride gas when it does not yet reacted with the alkali metal fluoride salt, whereas the consumption of hydrogen fluoride may damage the stability of the reaction system, the more serious results are that the normal operation of the reaction is affected due to insufficient hydrogen fluoride residue. For the tubular reactor, due to poor mixing effect, the phosphorus pentafluoride gas is mixed in the hydrogen halide gas and the gas phase is separated from the liquid phase to some extents, leading to the loss of phosphorus pentafluoride that cannot fully react with the alkali metal fluoride salt in the hydrogen fluoride solution. The use of the microreactor can effectively avoid the above problems, the excellent mixing effect ensures that the intermediate product phosphorus pentafluoride in the reaction sufficiently contacts with the alkali metal fluoride salt in hydrogen fluoride, phosphorus pentafluoride has been completely reacted when reaching the outlet of the microreactor, and the reaction has been ended, at this moment, even if a part of hydrogen fluoride in the reaction solution is entrained by hydrogen halide when the hydrogen halide gas is removed via gas-liquid separation, but the reaction at this moment has been ended, the lost hydrogen fluoride cannot create any adverse effects on the reaction. (4) The raw material hydrogen fluoride for synthesizing hexafluorophosphate, the intermediate product phosphorus pentafluoride and the mixture (III) obtained from the reaction are large in toxicity, the reaction process has significant safety risks. Therefore, the reduction of the liquid holding capacity of the reaction process can effectively reduce and avoid safety risks. The liquid holding capacity of an industrial-grade microreactor is in liter grade, and compared to the liquid holding capacities of the batch reactor and the tubular reactor, its safety risks are almost negligible.

When the reactor selects the microreactor, it can be a single microreactor or a microreactor group formed by tightly combining multiple microreactors, and its specific structure is determined by process conditions. The reaction temperature distribution in the microreactor can be uniform, or different temperature distributions can be formed inside the microreactor as required. If a uniform reaction temperature is used, the reaction temperature should not be higher than the boiling point of anhydrous hydrogen fluoride to ensure that hydrogen fluoride in the reaction mixture (III) flowing out of the outlet of the microreactor is in a liquid state. If there are different temperature distributions inside the microreactor, a temperature higher than the boiling point of anhydrous hydrogen fluoride can be allowed inside the microreactor. When the reaction mixture (III) flows to the outlet of the microreactor, a temperature when the mixture (III) flows out of the microreactor after cooling is lower than the boiling point of anhydrous hydrogen fluoride. The reaction temperature of the preferred microreactor is −40 to 100° C. During the reaction, the generated intermediate product phosphorus pentafluoride is a gas, and the generated hydrogen halide is also a gas. The generation of the gas inevitably leads to an increased internal pressure in the microreactor. In addition, if the reaction temperature of the microreactor is higher than the boiling point of anhydrous hydrogen fluoride, the gasification of hydrogen fluoride will also generate the pressure. Therefore, when the type of the microreactor is selected, it is needed to consider not only whether the material meets corrosion resistance requirement, but also the pressure resistance capability of the microreactor so as to ensure the safe reaction process. The material of the material contact area of the microreactor is preferably as follows: a non-metallic material is silicon carbide, and a metallic material is a high-nickel alloy material, such as Monel alloy and Hastelloy alloy. The pressure resistance capability of the microreactor must be higher than the maximum pressure that may occur during the reaction.

The feeding ratio of the phosphorus pentahalide inert solvent solution (I) to the alkali metal fluoride salt hydrogen fluoride solution (II) refers to a molar ratio of phosphorus contained in the phosphorus pentahalide inert solvent solution entering the microreactor within unit time to alkali metal contained in the alkali metal fluoride salt hydrogen fluoride solution entering the microreactor within unit time. Preferably, the molar ratio of phosphorus entering the microreactor within unit time to alkali metal entering the microreactor within unit time is (0.8-1.2):1, more preferably, the molar ratio of phosphorus entering the microreactor per unit time to alkali metal entering the microreactor within unit time is (0.9-1.1):1.

The feeding speeds of the phosphorus pentahalide inert solvent solution (I) and the alkali metal fluoride salt hydrogen fluoride solution (II) are closely related to the concentration and temperature of the phosphorus pentahalide inert solvent solution, the concentration and temperature of the alkali metal fluoride salt hydrogen fluoride solution, the volume and structure of the microreactor, the temperature and coolant flow of the cooling system, etc., which need to be determined by debugging according to relevant parameters during the actual running to ensure that the temperature in the microreactor is controlled at a temperature required by the process. Regardless of how to change the feeding speeds of the phosphorus pentahalide inert solvent solution (I) and the alkali metal fluoride salt hydrogen fluoride solution (II), after conversion, the feeding ratio of the mole of phosphorus contained in the phosphorus pentahalide inert solvent solution (I) to the mole of alkali metal contained in the alkali metal fluoride salt hydrogen fluoride solution (II) needs to be precisely controlled at the optimal process ratio to ensure that when the reaction solution reaches the outlet of the microreactor, phosphorus pentahalide and the alkali metal fluoride salt can both fully react to generate hexafluorophosphate, thereby not only improving the material utilization rate, but also facilitating the improvement of the product purity and the reaction yield.

in step (4),

the mixture (III) flowing out of the reactor consists of hexafluorophosphate, hydrogen fluoride, the inert solvent and hydrogen halide, the volatile hydrogen halide gas is separated out from the mixed solution by gas-liquid separation to obtain a mixture (IV) consisting of hexafluorophosphate, hydrogen fluoride and the inert solvent. The gas-liquid separation process can be carried out in a dedicated gas-liquid separation device, the mixture (IV) obtained by separation enters a collector, or the gas-liquid separation can also be carried out in the collector. If gas-liquid separation is carried out in the collector, the collector must have enough space for storing the mixture (IV) and performing gas-liquid separation, and meanwhile the collector should have temperature adjustment, condensation, foam removal and other functions. To keep the materials in the collector uniform, a collector with a stirring function is preferred. The material of the material contact area between the gas-liquid separator and the collector needs to be able to resist corrosion from hydrogen fluoride and hydrogen halide, etc., can be a non-metallic material such as silicon carbide, a high-nickel alloy material such as Monel alloy and Hastelloy alloy, or a corrosion-resistant polymer material such as polytetrafluoroethylene (PTFE) and perfluoroalkoxy (PFA).

The hydrogen fluoride entrained in the separated hydrogen halide gas is condensed and recovered in a multi-stage deep condensation manner, a few of residue hydrogen fluoride is removed by a multi-stage adsorption and defluorination manner to obtain a high-pure hydrogen halide gas, the high-pure hydrogen halide gas was absorbed with water to obtain a hydrogen halide solution which is used for a commercial purpose, with improved economic benefits. Of course, the hydrogen halide gas can also be subjected to purification and resource utilization by using other proper manners which are determined according to actual demands.

In the process of performing gas-liquid separation on the mixture (III) to obtain the mixture (IV), the operation temperature is required to be no higher than the boiling point of anhydrous hydrogen fluoride, so as to avoid the volatilization of the liquid hydrogen fluoride, thereby increasing the load and difficulty of the defluorination and purification operations of the hydrogen halide gas. The preferred gas-liquid separation temperature is −40 to 19° C.

in step (5),

the mixture (IV) consists of hexafluorophosphate, hydrogen fluoride and the inert solvent. After a certain quantity of mixture (IV) is collected, hydrogen fluoride is removed to obtain a mixture (V) consisting of hexafluorophosphate and the inert solvents. The removal of hydrogen fluoride can be carried out in the collector, or in a dedicated desolventizing kettle. If hydrogen fluoride is removed in the desolventizing kettle, the desolventizing kettle needs to have stirring, temperature adjustment, condensation, foam removal and other functions, the material of the material contact area of the desolventizing kettle needs to be able to resist corrosion from hydrogen fluoride, can be a non-metallic material such as silicon carbide, a high-nickel alloy material such as Monel alloy and Hastelloy alloy, or a corrosion-resistant polymer material such as PTFE and PFA.

The removal of hydrogen fluoride is that hydrogen fluoride is boiled and evaporated through a heating manner by using the properties of hydrogen fluoride such as low boiling point and high volatilization, thereby achieving the removal of hydrogen fluoride from the mixture. The hydrogen fluoride steam is condensed to condense the entrained inert solvent and return it back to the mixture, and then the hydrogen fluoride steam enters the hydrogen fluoride recovery system. To promote the removal rate and removal effect of hydrogen fluoride in the mixture (IV), in the process of removing hydrogen fluoride, especially before the end of the removal of hydrogen fluoride, the mixture is bubbled and blown by using dry inert gases such as nitrogen, helium and argon to ensure that hydrogen fluoride is sufficiently removed to obtain a mixture (V) without hydrogen fluoride residue. The hydrogen fluoride gas entering the hydrogen fluoride recovery system is subjected to multi-stage deep condensation to condense and recover hydrogen fluoride, and a tail gas obtained by deep condensation is defluorinated by multi-stage water and alkali spraying or multi-stage adsorption, and finally meets the standard to be discharged.

The operation temperature of the removal process of hydrogen fluoride is required to be higher than the boiling point of hydrogen fluoride, but less than the boiling point of the inert solvent, so as to avoid that the inert gas is entrained to enter the hydrogen fluoride recovery system while ensuring the smooth removal of hydrogen fluoride. The preferred operation temperature for removing hydrogen fluoride is 20-100° C. After the removal of hydrogen fluoride is ended, the mixture (V) consisting of hexafluorophosphate and the inert solvent is obtained. Although the hexafluorophosphate in the inert solvent is very small solubility and the temperature of the material has little influence on the solubility of hexafluorophosphate, however, for the sake of subsequent solid-liquid separation and promoting the safety of solid-liquid separation, the temperature of the mixture (V) should be reduced to room temperature or below.

in step (6),

The mixture (V) consists of hexafluorophosphate and the inert solvent, and a hexafluorophosphate finished product is obtained by solid-liquid separation and drying. The common solid-liquid separation operations, such as centrifugation, press filtration and suction filtration, are all suitable for solid-liquid separation of the mixture (V). The solid is obtained by solid-liquid separation and then dried to obtain the hexafluorophosphate finished product with a purity of more than 99.8% and a yield of more than 99.0%.

To further improve the quality of hexafluorophosphate and meet high-grade use demands, the obtained hexafluorophosphate is re-crystallized and purified to prepare ultra-pure hexafluorophosphate with a purity of more than 99.99% and more than 98%.

Compared with the prior art, the disclosure has the beneficial effects:

(1) The method for dissolving phosphorus pentahalide into the inert solvent to prepare the phosphorus pentahalide inert solvent solution and then feeding is adopted, thereby avoiding the feeding manner of using a phosphorus pentahalide solid or gas in the prior art, not only achieving the precise control of the phosphorus pentahalide feeding speed and feeding precision but also effectively solving the problem that the reaction between phosphorus pentahalide and hydrogen fluoride is excessively intense.

(2) Nitrile, ester, ether and ketone solvents containing nitrogen and oxygen atoms in the prior art are replaced with solvents, such as alkane solvents, halogenated alkane solvents, aromatic solvents and halogenated aromatic solvents, that are inert relative to the reaction system, so as to ensure the complete inertness of the solvents during the reaction, avoid side reactions such as decomposition and complexation involving solvents, improve reaction yield and product purity, simplify solvent recovery operations, and improve solvent recovery rate.

(3) By adopting the method for in-situ generation of phosphorus pentafluoride and in-situ reaction with alkali metal fluorides, the separation, purification, storage, transportation and other operations of phosphorus pentafluoride are avoided, and the gaseous feeding method of phosphorus pentafluoride is eliminated, the utilization rate of phosphorus pentafluoride is effectively improved, the operation process is simplified, production efficiency is improved, and synthesis costs are reduced.

(4) The method for gradually separating different components of materials in stages is adopted to separate the hydrogen halide generated by the reaction, the surplus raw material hydrogen fluoride, the inert solvent of the reaction, and the product hexafluorophosphate in sequence. The separation sequence is rationalized, the separation process is simplified, and the separation effect is optimized to minimize the generation of mixed materials, achieve the resource utilization of various materials, and minimize the amount of three wastes, among them, recovered hydrogen halide can be used to prepare high-purity hydrogen halide aqueous solutions for commercial purposes, recover hydrogen fluoride and inert solvents, and can be used in reactions to maximize economic benefits.

(5) The product hexafluorophosphate is obtained through solid-liquid separation from a mixture of hexafluorophosphate and an inert solvent, thereby avoiding that the existing product hexafluorophosphate is obtained through solid-liquid separation from hydrogen fluoride solution, greatly improving the safety and operability of the solid-liquid separation process and subsequent purification and drying processes. Moreover, the separated hexafluorophosphate has less residual hydrogen fluoride and better product quality.

(6) The synthesis method of hexafluorophosphate according to the disclosure involves solid feeding in the preparation of solutions using raw materials such as phosphorus pentahalide and alkali metal halide salts, as well as solid discharge in the final product obtained through solid-liquid separation and drying. All other processes can achieve continuous flow and automated production, which can conveniently achieve a continuous reaction mode of “kettle continuous-continuous flow-kettle continuous” and avoid the existing technology of full kettle intermittent reaction mode, significantly improve the safety of the production process and improve production efficiency.

Next, the disclosure will be further described in combination with drawings and specific embodiments. It is noted here that the following embodiments are only for helping the understanding of the disclosure, but are not intended to limit the disclosure. Specific embodiments cannot fully utilize all the technical features of the disclosure, as long as the technical features mentioned in the specification do not conflict with each other and can be combined to form new embodiments.

### DESCRIPTION OF THE DRAWINGS

FIG. 1 is a schematic diagram of a continuous synthesis flow process of hexafluorophosphate in the disclosure, which includes “kettle continuous-continuous flow-kettle continuous”.

### DETAILED DESCRIPTION OF PREFERRED EMBODIMENTS

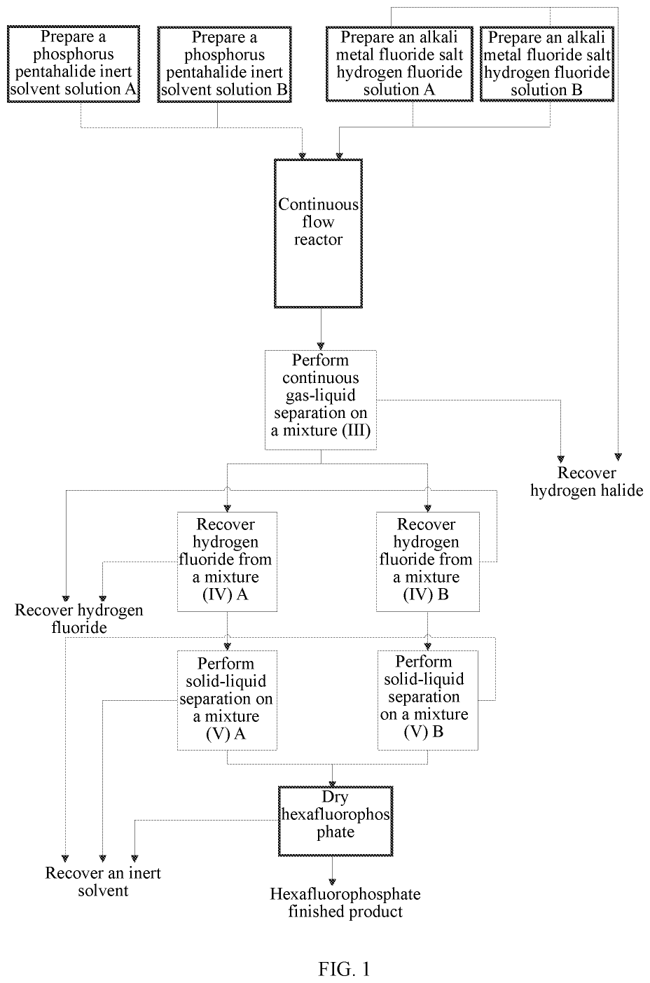

In combination with FIG. 1, the disclosure adopts the continuous reaction process “kettle continuous-continuous flow-kettle continuous” to synthesize lithium hexafluorophosphate. The specific flow process is as follows:

(1) preparation of a phosphorus pentahalide inert solvent solution adopts an AB two-line system, wherein the AB two lines operate in a cross manner. When a phosphorus pentahalide solution is prepared for the A line, the phosphorus pentahalide solution is fed for the B line. Conversely, when the phosphorus pentahalide solution is prepared for the B line, the phosphorus pentahalide solution is fed for the A line. As such, the continuous feeding of the phosphorus pentahalide inert solvent solution can be achieved.

(2) Preparation of an alkali metal fluoride salt hydrogen fluoride solution adopts an AB two-line system, wherein the AB two lines operate in a cross manner. When an alkali metal fluoride salt solution is prepared for the A line, the alkali metal fluoride salt solution is fed for the B line. Conversely, when the alkali metal fluoride salt solution is prepared for the B line, the alkali metal fluoride salt solution is fed for the A line. As such, the continuous feeding of the alkali metal fluoride salt hydrogen fluoride solution can be achieved; when the alkali metal fluoride salt uses an alkali metal chloride salt or an alkali metal bromide salt, the generated hydrogen halide gas enters a hydrogen halide treatment system.

(3) The phosphorus pentahalide inert solvent solution and the alkali metal fluoride salt hydrogen fluoride solution are input into a continuous-flow reactor for reaction in a ratio via a metering pump, parameter setting and adjustment are performed on a feeding ratio, a feeding speed, a reaction temperature, a retention time and the like according to process requirements, and continuous reaction, continuous feeding and continuous discharge are achieved.

(4) The mixture (III) at the outlet of the continuous-flow reactor is subjected to continuous gas-liquid separation to remove hydrogen halide to obtain the mixture (IV), the removed hydrogen halide gas enters the hydrogen halide treatment system.

(5) The mixture (IV) was subjected to collection and removal of hydrogen fluoride to obtain the mixture (V), the mixture (V) is subjected to solid-liquid separation to obtain hexafluorophosphate, the above operations adopt an AB two-line system, the AB two lines operate in a cross manner, when the mixture (IV) is collected for the A line, hydrogen fluoride is removed from the mixture (IV) for the B line to obtain the mixture (V), the mixture (V) is subjected to solid-liquid separation to obtain hexafluorophosphate; when the mixture (IV) is collected for the B line, hydrogen fluoride is removed from the mixture (IV) for the A line to obtain the mixture (V), the mixture (V) is subjected to solid-liquid separation to obtain hexafluorophosphate. As such, on one hand, a continuous gas-liquid separator is seamlessly connected, and on the other hand, continuous hydrogen fluoride removal and solid-liquid separation operations can be achieved so as to ensure the continuous and stable operation of the synthesis process; the removed hydrogen fluoride enters the hydrogen fluoride recovery system, and the inert solvent obtained from solid-liquid separation returns back to the preparation process of the phosphorus pentahalide inert solvent solution.

(6) Hexafluorophosphate is dried to obtain a hexafluorophosphate finished product, and the package process of the hexafluorophosphate finished product is carried out in a single line, continuous drying and continuous package devices are rationally matched according to actual capacity, thereby achieving the continuous drying and continuous packaging operations of hexafluorophosphate.

### Example 1

Lithium hexafluorophosphate was synthesized by using a microreactor as a continuous reactor, phosphorus pentachloride, lithium chloride and hydrogen fluoride as raw materials and toluene as an inert organic solvent. By combining with a process flowchart 1, the synthesis process was as follows:

(1) quantitative toluene was added into a phosphorus pentachloride toluene solution preparation kettle, a quantitative phosphorus pentachloride solid was added under the protection of nitrogen, the temperature was raised to 60-65° C. under the condition of stirring, and the temperature was reduced to 20-25° C. after the solid was completely dissolved, so as to obtain a phosphorus pentachloride toluene solution with a mass concentration of 25%, which was stored for later use under the protection of nitrogen. The phosphorus pentachloride toluene solution preparation kettle was divided into AB kettles which were used interchangeably.

(2) A quantitative anhydrous hydrogen fluoride liquid was added to a lithium fluoride hydrogen fluoride solution preparation kettle, the temperature was controlled at −10 to −5° C. under the protection of nitrogen, and then a quantitative lithium chloride solid was slowly added in batch and dissolved under the condition of stirring, so as to obtain a lithium fluoride hydrogen fluoride solution with a mass concentration of 20%, which was stored for later use at −10 to −5° C. under the protection of nitrogen; the hydrogen chloride gas generated in the preparation process entered a hydrogen chloride treatment system. The lithium fluoride hydrogen fluoride solution preparation kettle was divided into AB kettles which were used interchangeably.

(3) The phosphorus pentachloride toluene solution was continuously input into the microreactor at the speed of 500 g/min via a metering pump, the lithium fluoride hydrogen fluoride solution was continuously input into the microreactor at the speed of 77.85 g/min via the metering pump, the two materials were sufficiently mixed at the inlet of the microreactor and then reacted in the microreactor, the microreactor adopted step temperature control, wherein the maximum temperature in the middle of the microreactor was controlled at 60-65° C., and the temperature of the outlet of the microreactor was controlled at −15 to −10° C., and the materials stayed for about 80 seconds in the microreactor.

(4) The reaction solution flew out of the microreactor and then entered a continuous gas-liquid separator, wherein the temperature of the gas-liquid separator was controlled at −15 to −10° C., the gas separated from the gas-liquid separator entered the hydrogen chloride treatment system, the liquid separated from the gas-liquid separator entered a collection kettle, wherein the temperature of the collection kettle was controlled at 0-5° C. The collection kettle was divided into AB kettles which were used interchangeably.

(5) After the material in the collection kettle was completely collected, the temperature of the collection kettle was slowly raised to 40-45° C. so that hydrogen fluoride was removed by evaporation, the hydrogen fluoride steam entered a hydrogen fluoride recovery system, dry nitrogen was introduced after most of the hydrogen fluoride was removed to purge the materials for 2 hours at 40-45° C., the temperature of the collection kettle was reduced to 5-10° C. after purging was ended, then a lithium hexafluorophosphate wet solid was obtained by centrifugation, and centrifuge mother liquor was used as recovered toluene to return back to a toluene groove of a phosphorus pentachloride toluene solution preparation process.

(6) The lithium hexafluorophosphate wet solid entered a single-cone spiral belt dryer via a solid material delivery system to be dried at reduced pressure, and then packaged through an automatic passage machine after being qualified via detection.

The hydrogen chloride treatment system: the hydrogen chloride treatment system consists of a three-stage tandem condenser, a two-stage defluorination packing tower, a three-stage falling film absorber and a two-stage alkali spraying tower. In the three-stage tandem condenser, a −35 to −30° C. frozen liquid was introduced, and hydrogen fluoride entrained in hydrogen chloride was condensed and recovered; in the two-stage defluorination packing tower, a hydrogen fluoride adsorption filler was loaded in the tower to remove a small amount of residual hydrogen fluoride in hydrogen chloride subjected to condensation and defluorination; high-pure hydrogen chloride obtained by defluorination treatment was absorbed with water in the three-stage falling film absorber to obtain a hydrogen chloride solution with a concentration of 35-36%; after being deacidified by secondary alkali spraying, the tail gas met the standard to be discharged.

The hydrogen fluoride recovery system: the hydrogen fluoride recovery system consists of a three-stage tandem condenser, a three-stage falling film absorber, and a two-stage alkali spraying tower. In the three-stage tandem condenser, a −35 to −30° C. frozen liquid was introduced, most of the hydrogen fluoride was condensed and recovered; hydrogen fluoride left in the tail gas was absorbed with water in the three-stage falling film absorber to obtain a hydrofluoric acid solution with a concentration of 49±0.2%; after being deacidified by secondary alkali spraying, the tail gas met the standard to be discharged.

The synthesis of lithium hexafluorophosphate in this example spent 10 hours from starting feeding to stable debugging. Starting from the completion of debugging, timing was started and stable operation was carried out for 300 hours. The results are summarized as follows: a total of 2250 kg of phosphorus pentachloride and 458 kg of lithium chloride were consumed, resulting in 1630 kg of lithium hexafluorophosphate finished product with a yield of 99.3% and a purity of 99.85%.

### Example 2

Sodium hexafluorophosphate was synthesized by using a microreactor as a continuous reactor, phosphorus pentachloride, sodium fluoride and hydrogen fluoride as raw materials and chlorobenzene as an inert organic solvent. By combining with a process flowchart 1, the synthesis process was as follows:

(1) quantitative chlorobenzene was added into a phosphorus pentachloride chlorobenzene solution preparation kettle, a quantitative phosphorus pentachloride solids was added under the protection of nitrogen, the temperature was raised to 50-55° C. under the condition of stirring, and the temperature was reduced to 10-15° C. after the solid was completely dissolved, so as to obtain a phosphorus pentachloride chlorobenzene solution with a mass concentration of 20%, which was stored for later use under the protection of nitrogen. The phosphorus pentachloride chlorobenzene solution preparation kettle was divided into AB kettles which were used interchangeably.

(2) A quantitative anhydrous hydrogen fluoride liquid was added to a sodium fluoride hydrogen fluoride solution preparation kettle, the temperature was controlled at 10-15° C. under the protection of nitrogen, and then a quantitative sodium chloride solid was slowly added in batch and dissolved under the condition of stirring, so as to obtain a sodium fluoride hydrogen fluoride solution with a mass concentration of 30%, which was stored for later use at 10-15° C. under the protection of nitrogen. The sodium fluoride hydrogen fluoride solution preparation kettle was divided into AB kettles which were used interchangeably.

(3) The phosphorus pentachloride chlorobenzene solution was continuously input into the microreactor at the speed of 550 g/min via a metering pump, the lithium fluoride hydrogen fluoride solution was continuously input into the microreactor at the speed of 73.94 g/min via the metering pump, the two materials were sufficiently mixed at the inlet of the microreactor and then reacted in the microreactor, the microreactor adopted step temperature control, wherein the maximum temperature in the middle of the microreactor was controlled at 70-75° C., and the temperature of the outlet of the microreactor was controlled at −10 to −5° C., and the materials stayed for about 70 seconds in the microreactor.

(4) The reaction solution flew out of the microreactor and then entered a continuous gas-liquid separator, wherein the temperature of the gas-liquid separator was controlled at −5 to 0° C., the gas separated from the gas-liquid separator entered the hydrogen chloride treatment system, the liquid separated from the gas-liquid separator entered a collection kettle, wherein the temperature of the collection kettle was controlled at −5 to 5° C. The collection kettle was divided into AB kettles which were used interchangeably.

(5) After the material in the collection kettle was completely collected, the temperature of the collection kettle was slowly raised to 50-55° C. so that hydrogen fluoride was removed by evaporation, the hydrogen fluoride steam entered a hydrogen fluoride recovery system, dry nitrogen was introduced after hydrogen fluoride was basically removed to purge the materials for 2 hours at 50-55° C., the temperature of the collection kettle was reduced to 25-25° C. after purging was ended, then a sodium hexafluorophosphate wet solid was obtained by centrifugation, and centrifuge mother liquor was used as recovered chlorobenzene to return back to a chlorobenzene groove of a phosphorus pentachloride chlorobenzene solution preparation process.

(6) The sodium hexafluorophosphate wet solid entered a single-cone spiral belt dryer via a solid material delivery system to be dried at reduced pressure, and then packaged through an automatic passage machine after being qualified via detection.

The hydrogen chloride treatment system: the hydrogen chloride treatment system consists of a three-stage tandem condenser, a two-stage defluorination packing tower, a three-stage falling film absorber and a two-stage alkali spraying tower. In the three-stage tandem condenser, a −35 to −30° C. frozen liquid was introduced, and hydrogen fluoride entrained in hydrogen chloride was condensed and recovered; in the two-stage defluorination packing tower, a hydrogen fluoride adsorption filler was loaded in the tower to remove a small amount of residual hydrogen fluoride in hydrogen chloride subjected to condensation and defluorination; high-pure hydrogen chloride obtained by defluorination treatment was absorbed with water in the three-stage falling film absorber to obtain a hydrogen chloride solution with a concentration of 35-36%; after being deacidified by secondary alkali spraying, the tail gas met the standard to be discharged.

The hydrogen fluoride recovery system: a three-stage tandem condenser, a three-stage falling film absorber and a two-stage alkali spraying tower. In the three-stage tandem condenser, a −35 to −30° C. frozen liquid was introduced, most of the hydrogen fluoride was condensed and recovered; residual hydrogen fluoride in the tail gas was absorbed with water in the three-stage falling film absorber to obtain a hydrofluoric acid solution with a concentration of 49±0.2%; after being deacidified by secondary alkali spraying, the tail gas met the standard to be discharged.

The synthesis of sodium hexafluorophosphate in this example spent 10 hours from starting feeding to stable debugging. Starting from the completion of debugging, timing was started and stable operation was carried out for 300 hours. The results are summarized as follows: a total of 1980 kg of phosphorus pentachloride and 399 kg of sodium fluoride were consumed, resulting in 1589 kg of sodium hexafluorophosphate finished product with a yield of 99.5% and a purity of 99.83%.

### Example 3

Potassium hexafluorophosphate was synthesized by using a microreactor as a continuous reactor, phosphorus pentachloride, potassium chloride and hydrogen fluoride as raw materials and chloroform as an inert organic solvent. By combining with a process flowchart 1, the synthesis process was as follows:

(1) quantitative chloroform was added into a phosphorus pentachloride chloroform solution preparation kettle, a quantitative phosphorus pentachloride solid was added under the protection of nitrogen, the temperature was raised to 40-45° C. under the condition of stirring, the temperature was reduced to 20-25° C. after the solid was completely dissolved, so as to obtain a phosphorus pentachloride chloroform solution with a mass concentration of 30%, which was stored for later use under the protection of nitrogen. The phosphorus pentachloride chloroform solution preparation kettle was divided into AB kettles which were used interchangeably.

(2) A quantitative anhydrous hydrogen fluoride liquid was added to a potassium fluoride hydrogen fluoride solution preparation kettle, the temperature was controlled at −15 to −10° C. under the protection of nitrogen, and then a quantitative potassium chloride solid was slowly added in batch and dissolved under the condition of stirring, so as to obtain a potassium fluoride hydrogen fluoride solution with amass concentration of 35%, which was stored for later use at −15 to −10° C. under the protection of nitrogen; the hydrogen chloride gas generated in the preparation process entered a hydrogen chloride treatment system. The potassium fluoride hydrogen fluoride solution preparation kettle was divided into AB kettles which were used interchangeably.

(3) The phosphorus pentachloride chloroform solution was continuously input into the microreactor at the speed of 450 g/min via a metering pump, the potassium fluoride hydrogen fluoride solution was continuously input into the microreactor at the speed of 107.62 g/min via the metering pump, the two materials were sufficiently mixed at the inlet of the microreactor and then reacted in the microreactor, the microreactor adopted step temperature control, wherein the maximum temperature in the middle of the microreactor was controlled at 40-45° C., and the temperature of the outlet of the microreactor was controlled at −15 to −10° C., and the materials stayed for about 90 seconds in the microreactor.

(4) The reaction solution flew out of the mciroreactor and then entered a continuous gas-liquid separator, wherein the temperature of the gas-liquid separator was controlled at −10 to −5° C., the gas separated from the gas-liquid separator entered the hydrogen chloride treatment system, the liquid separated from the gas-liquid separator entered a collection kettle, wherein the temperature of the collection kettle was controlled at 0-5° C. The collection kettle was divided into AB kettles which were used interchangeably.

(5) After the material in the collection kettle was completely collected, the temperature of the collection kettle was slowly raised to 50-55° C. so that hydrogen fluoride was removed by evaporation, the hydrogen fluoride steam entered a hydrogen fluoride recovery system, the temperature of the collection kettle was reduced to 0-5° C. after removal of hydrogen fluoride was ended, the material was subjected to filter press to obtain a potassium hexafluorophosphate wet solid, and mother liquor after filter press was used as recovered chloroform to return back to a chloroform groove of a phosphorus pentachloride chloroform solution preparation process.

(6) The potassium hexafluorophosphate wet solid entered a single-cone spiral belt dryer via a solid material delivery system to be dried at reduced pressure, and then packaged through an automatic passage machine after being qualified via detection.

The hydrogen chloride treatment system: the hydrogen chloride treatment system consists of a three-stage tandem condenser, a two-stage defluorination packing tower, a three-stage falling film absorber and a two-stage alkali spraying tower. In the three-stage tandem condenser, a −35 to −30° C. frozen liquid was introduced, and hydrogen fluoride entrained in hydrogen chloride was condensed and recovered; in the two-stage defluorination packing tower, a hydrogen fluoride adsorption filler was loaded in the tower to remove a small amount of residual hydrogen fluoride in hydrogen chloride subjected to condensation and defluorination; high-pure hydrogen chloride obtained by defluorination treatment was absorbed with water in the three-stage falling film absorber to obtain a hydrogen chloride solution with a concentration of 35-36%; after being deacidified by secondary alkali spraying, the tail gas met the standard to be discharged.

The hydrogen fluoride recovery system: the hydrogen fluoride recovery system consists of a three-stage tandem condenser, a three-stage falling film absorber, and a two-stage alkali spraying tower. In the three-stage tandem condenser, a −35 to −30° C. frozen liquid was introduced, most of the hydrogen fluoride was condensed and recovered; hydrogen fluoride left in the tail gas was absorbed with water in the three-stage falling film absorber to obtain a hydrofluoric acid solution with a concentration of 49±0.2%; after being deacidified by secondary alkali spraying, the tail gas met the standard to be discharged.

The synthesis of potassium hexafluorophosphate in this example spent 10 hours from starting feeding to stable debugging. Starting from the completion of debugging, timing was started and stable operation was carried out for 300 hours. The results are summarized as follows: a total of 2430 kg of phosphorus pentachloride and 870 kg of potassium chloride were consumed, resulting in 2131 kg of potassium hexafluorophosphate finished product with a yield of 99.2% and a purity of 99.88%.

### Example 4

Sodium hexafluorophosphate was synthesized by using a microreactor as a continuous reactor, phosphorus pentachloride, sodium chloride and hydrogen fluoride as raw materials and toluene as an inert organic solvent. By combining with a process flowchart 1, the synthesis process was as follows:

(1) quantitative m-dichlorobenzene was added into a phosphorus pentachloride m-dichlorobenzene solution preparation kettle, a quantitative phosphorus pentachloride solid was added under the protection of nitrogen, the temperature was raised to 70-75° C. under the condition of stirring, the temperature was reduced to 25-30° C. after the solid was completely dissolved, so as to obtain a phosphorus pentachloride m-dichlorobenzene solution with a mass concentration of 30%, which was stored for later use under the protection of nitrogen. The phosphorus pentachloride m-dichlorobenzene solution preparation kettle was divided into AB kettles which were used interchangeably.

(2) A quantitative anhydrous hydrogen fluoride liquid was added to a sodium fluoride hydrogen fluoride solution preparation kettle, the temperature was controlled at 0-5° C. under the protection of nitrogen, and then a quantitative sodium chloride solid was slowly added in batch and dissolved under the condition of stirring, so as to obtain a sodium fluoride hydrogen fluoride solution with a mass concentration of 25%, which was stored for later use at 0 to 5° C. under the protection of nitrogen; the hydrogen chloride gas generated in the preparation process entered a hydrogen chloride treatment system. The sodium fluoride hydrogen fluoride solution preparation kettle was divided into AB kettles which were used interchangeably.

(3) The phosphorus pentachloride m-dichlorobenzene solution was continuously input into the microreactor at the speed of 450 g/min via a metering pump, the sodium fluoride hydrogen fluoride solution was continuously input into the microreactor at the speed of 108.89 g/min via the metering pump, the two materials were sufficiently mixed at the inlet of the microreactor and then reacted in the microreactor, and the microreactor adopted step temperature control, wherein the maximum temperature in the middle of the microreactor was controlled at 30-35° C., and the temperature of the outlet of the microreactor was controlled at −5 to 0° C., and the materials stayed for about 90 seconds in the microreactor.

(4) The reaction solution flew out of the mciroreactor and then entered a continuous gas-liquid separator, wherein the temperature of the gas-liquid separator was controlled at −5 to 0° C., the gas separated from the gas-liquid separator entered the hydrogen chloride treatment system, and the liquid separated from the gas-liquid separator entered a collection kettle, wherein the temperature of the collection kettle was controlled at −5 to 0° C. The collection kettle was divided into AB kettles which were used interchangeably.

(5) After the material in the collection kettle was completely collected, the temperature of the collection kettle was slowly raised to 60-65° C., hydrogen fluoride was removed by evaporation, the hydrogen fluoride steam entered a hydrogen fluoride recovery system, dry nitrogen was introduced after most of the hydrogen fluoride was removed to purge the materials for 2 hours at 60-65° C., the temperature of the collection kettle was reduced to 15-20° C. after purging was ended, then a sodium hexafluorophosphate wet solid was obtained by centrifugation, and centrifuge mother liquor was used as recovered m-dichlorobenzene to return back to an m-dichlorobenzene groove of a phosphorus pentachloride m-dichlorobenzene solution preparation process.

(6) The sodium hexafluorophosphate wet solid entered a single-cone spiral belt dryer via a solid material delivery system to be dried at reduced pressure, and then packaged through an automatic passage machine after being qualified via detection.

The hydrogen chloride treatment system: the hydrogen chloride treatment system consists of a three-stage tandem condenser, a two-stage defluorination packing tower, a three-stage falling film absorber and a two-stage alkali spraying tower. In the three-stage tandem condenser, a −35 to −30° C. frozen liquid was introduced, and hydrogen fluoride entrained in hydrogen chloride was condensed and recovered; in the two-stage defluorination packing tower, a hydrogen fluoride adsorption filler was loaded in the tower to remove a small amount of residual hydrogen fluoride in hydrogen chloride subjected to condensation and defluorination; high-pure hydrogen chloride obtained by defluorination treatment was absorbed with water in the three-stage falling film absorber to obtain a hydrogen chloride solution with a concentration of 35-36%; after being deacidified by secondary alkali spraying, the tail gas met the standard to be discharged.

The hydrogen fluoride recovery system: the hydrogen fluoride recovery system consists of a three-stage tandem condenser, a three-stage falling film absorber, and a two-stage alkali spraying tower. In the three-stage tandem condenser, a −35 to −30° C. frozen liquid was introduced, most of the hydrogen fluoride was condensed and recovered; hydrogen fluoride left in the tail gas was absorbed with water in the three-stage falling film absorber to obtain a hydrofluoric acid solution with a concentration of 49±0.2%; after being deacidified by secondary alkali spraying, the tail gas met the standard to be discharged.

The synthesis of sodium hexafluorophosphate in this example spent 10 hours from starting feeding to stable debugging. Starting from the completion of debugging, timing was started and stable operation was carried out for 300 hours. The results are summarized as follows: a total of 2430 kg of phosphorus pentachloride and 682 kg of sodium chloride were consumed, resulting in 1942 kg of lithium hexafluorophosphate finished product with a yield of 99.1% and a purity of 99.90%.

### Example 5

Lithium hexafluorophosphate was synthesized by using a microreactor as a continuous reactor, phosphorus pentachloride, lithium fluoride and hydrogen fluoride as raw materials and toluene as an inert organic solvent. By combining with a process flowchart 1, the synthesis process was as follows:

(1) quantitative dichloroethane was added into a phosphorus pentachloride dichloroethane solution preparation kettle, a quantitative phosphorus pentachloride solid was added under the protection of nitrogen, the temperature was raised to 60-65° C. under the condition of stirring, the temperature was reduced to 20-25° C. after the solid was completely dissolved, so as to obtain a phosphorus pentachloride dichloroethane solution with a mass concentration of 25%, which was stored for later use under the protection of nitrogen. The phosphorus pentachloride dichloroethane solution preparation kettle was divided into AB kettles which were used interchangeably.

(2) A quantitative anhydrous hydrogen fluoride liquid was added to a lithium fluoride hydrogen fluoride solution preparation kettle, the temperature was controlled at 5-10° C. under the protection of nitrogen, and then a quantitative lithium fluoride solid was slowly added in batch and dissolved under the condition of stirring, so as to obtain a lithium fluoride hydrogen fluoride solution with a mass concentration of 25%, which was stored for later use at 5-10° C. under the protection of nitrogen. The lithium fluoride hydrogen fluoride solution preparation kettle was divided into AB kettles which were used interchangeably.

(3) The phosphorus pentachloride dichloroethane solution was continuously input into the microreactor at the speed of 500 g/min via a metering pump, the lithium fluoride hydrogen fluoride solution was continuously input into the microreactor at the speed of 62.28 g/min via the metering pump, the two materials were sufficiently mixed at the inlet of the microreactor and then reacted in the microreactor, the microreactor adopted step temperature control, wherein the maximum temperature in the middle of the microreactor was controlled at 50-55° C., and the temperature of the outlet of the microreactor was controlled at 0-5° C., and the materials stayed for about 80 seconds in the microreactor.

(4) The reaction solution flew out of the mciroreactor and then entered a continuous gas-liquid separator, wherein the temperature of the gas-liquid separator was controlled at −20 to −15° C., the gas separated from the gas-liquid separator entered the hydrogen chloride treatment system, the liquid separated from the gas-liquid separator entered a collection kettle, wherein the temperature of the collection kettle was controlled at −5 to 5° C. The collection kettle was divided into AB kettles which were used interchangeably.

(5) After the material in the collection kettle was completely collected, the temperature of the collection kettle was slowly raised to 60-65° C., hydrogen fluoride was removed by evaporation, the hydrogen fluoride steam entered a hydrogen fluoride recovery system, after removal of the hydrogen fluoride was ended, the temperature of the collection kettle was reduced to 10-15° C., then a lithium hexafluorophosphate wet solid was obtained by centrifugation, and centrifuge mother liquor was used as recovered dichloroethane to return back to a dichloroethane groove of a phosphorus pentachloride dichloroethane solution preparation process.

(6) The lithium hexafluorophosphate wet solid entered a single-cone spiral belt dryer via a solid material delivery system to be dried at reduced pressure, and then packaged through an automatic passage machine after being qualified via detection.

The hydrogen chloride treatment system: the hydrogen chloride treatment system consists of a three-stage tandem condenser, a two-stage defluorination packing tower, a three-stage falling film absorber and a two-stage alkali spraying tower. In the three-stage tandem condenser, a −35 to −30° C. frozen liquid was introduced, and hydrogen fluoride entrained in hydrogen chloride was condensed and recovered; in the two-stage defluorination packing tower, a hydrogen fluoride adsorption filler was loaded in the tower to remove a small amount of residual hydrogen fluoride in hydrogen chloride subjected to condensation and defluorination; high-pure hydrogen chloride obtained by defluorination treatment was absorbed with water in the three-stage falling film absorber to obtain a hydrogen chloride solution with a concentration of 35-36%; after being deacidified by secondary alkali spraying, the tail gas met the standard to be discharged.

The hydrogen fluoride recovery system: the hydrogen fluoride recovery system consists of a three-stage tandem condenser, a three-stage falling film absorber, and a two-stage alkali spraying tower. In the three-stage tandem condenser, a −35 to −30° C. frozen liquid was introduced, most of the hydrogen fluoride was condensed and recovered; hydrogen fluoride left in the tail gas was absorbed with water in the three-stage falling film absorber to obtain a hydrofluoric acid solution with a concentration of 49±0.2%; after being deacidified by secondary alkali spraying, the tail gas met the standard to be discharged.

The synthesis of lithium hexafluorophosphate in this example spent 10 hours from starting feeding to stable debugging. Starting from the completion of debugging, timing was started and stable operation was carried out for 300 hours. The results are summarized as follows: a total of 2250 kg of phosphorus pentachloride and 280 kg of lithium fluoride were consumed, resulting in 1631 kg of lithium hexafluorophosphate finished product with a yield of 99.4% and a purity of 99.86%.

### Example 6

Potassium hexafluorophosphate was synthesized by using a microreactor as a continuous reactor, phosphorus pentachloride, potassium bromide and hydrogen fluoride as raw materials and methylcyclohexane as an inert organic solvent. By combining with a process flowchart 1, the synthesis process was as follows:

(1) quantitative methylcyclohexane was added into a phosphorus pentachloride methylcyclohexane solution preparation kettle, a quantitative phosphorus pentachloride solid was added under the protection of nitrogen, the temperature was raised to 30-35° C. under the condition of stirring, a phosphorus pentachloride methylcyclohexane solution with a mass concentration of 15% was obtained after the solid was completely dissolved, which was stored for later use under the protection of nitrogen. The phosphorus pentachloride methylcyclohexane solution preparation kettle was divided into AB kettles which were used interchangeably.

(2) A quantitative anhydrous hydrogen fluoride liquid was added to a potassium fluoride hydrogen fluoride solution preparation kettle, the temperature was controlled at −5 to 0° C. under the protection of nitrogen, and then a quantitative potassium bromide solid was slowly added in batch and dissolved under the condition of stirring, so as to obtain a potassium fluoride hydrogen fluoride solution with amass concentration of 40%, which was stored for later use at −5 to 0° C. under the protection of nitrogen; the hydrogen bromide gas generated in the preparation process entered a hydrogen bromide treatment system. The potassium fluoride hydrogen fluoride solution preparation kettle was divided into AB kettles which were used interchangeably.

(3) The phosphorus pentachloride methylcyclohexane solution was continuously input into the microreactor at the speed of 600 g/min via a metering pump, the potassium fluoride hydrogen fluoride solution was continuously input into the microreactor at the speed of 30.37 g/min via the metering pump, the two materials were sufficiently mixed at the inlet of the microreactor and then reacted in the microreactor, and the microreactor adopted step temperature control, wherein the maximum temperature in the middle of the microreactor was controlled at 80-85° C., and the temperature of the outlet of the microreactor was controlled at −10 to −5° C., and the materials stayed for about 60 seconds in the microreactor.

(4) The reaction solution flew out of the mciroreactor and then entered a continuous gas-liquid separator, wherein the temperature of the gas-liquid separator was controlled at −10 to −5° C., the gas separated from the gas-liquid separator entered the hydrogen bromide treatment system, and the liquid separated from the gas-liquid separator entered a collection kettle, wherein the temperature of the collection kettle was controlled at −5 to 5° C. The collection kettle was divided into AB kettles which were used interchangeably.

(5) After the material in the collection kettle was completely collected, the temperature of the collection kettle was slowly raised to 70-75° C., hydrogen fluoride was removed by evaporation, the hydrogen fluoride steam entered a hydrogen fluoride recovery system, the temperature of the collection kettle was reduced to 20-25° C. after removal of hydrogen fluoride was ended, then a potassium hexafluorophosphate wet solid was obtained by filter pressing, and mother liquor obtained after filter pressing was used as recovered methylcyclohexane to return back to a methylcyclohexane groove of a phosphorus pentachloride methylcyclohexane solution preparation process.

(6) The potassium hexafluorophosphate wet solid entered a single-cone spiral belt dryer via a solid material delivery system to be dried at reduced pressure, and then packaged through an automatic passage machine after being qualified via detection.

The hydrogen bromide treatment system: the hydrogen bromide treatment system consists of a three-stage tandem condenser, a two-stage defluorination packing tower, a three-stage falling film absorber and a two-stage alkali spraying tower. In the three-stage tandem condenser, a −35 to −30° C. frozen liquid was introduced, and hydrogen fluoride entrained in hydrogen bromide was condensed and recovered; in the two-stage defluorination packing tower, a hydrogen fluoride adsorption filler was loaded in the tower to remove a small amount of residual hydrogen fluoride in hydrogen bromide after condensation and defluorination; high-pure hydrogen bromide obtained by defluorination treatment was absorbed with water in the three-stage falling film absorber to obtain a hydrogen bromide solution with a concentration of 46-48%; after being deacidified by secondary alkali spraying, the tail gas met the standard to be discharged.

The hydrogen fluoride recovery system: the hydrogen fluoride recovery system consists of a three-stage tandem condenser, a three-stage falling film absorber, and a two-stage alkali spraying tower. In the three-stage tandem condenser, a −35 to −30° C. frozen liquid was introduced, most of the hydrogen fluoride was condensed and recovered; hydrogen fluoride left in the tail gas was absorbed with water in the three-stage falling film absorber to obtain a hydrofluoric acid solution with a concentration of 49±0.2%; after being deacidified by secondary alkali spraying, the tail gas met the standard to be discharged.

The synthesis of potassium hexafluorophosphate in this example spent 10 hours from starting feeding to stable debugging. Starting from the completion of debugging, timing was started and stable operation was carried out for 300 hours. The results are summarized as follows: a total of 1620 kg of phosphorus pentachloride and 448 kg of potassium bromide were consumed, resulting in 688 kg of potassium hexafluorophosphate finished product with a yield of 99.3% and a purity of 99.84%.

We claim:

1. A synthesis method of hexafluorophosphate, comprising the following steps:
(1) dissolving phosphorus pentahalide into an inert solvent to obtain a phosphorus pentahalide inert solvent solution;
(2) dissolving an alkali metal halide salt into anhydrous hydrogen fluoride to obtain an alkali metal fluoride salt hydrogen fluoride solution;
(3) reacting the phosphorus pentahalide inert solvent solution with the alkali metal fluoride salt hydrogen fluoride solution in a reactor in a ratio to obtain a mixture consisting of hexafluorophosphate, hydrogen fluoride, the inert solvent and hydrogen halide;
wherein, instep (3), a feeding ratio of the phosphorus pentahalide inert solvent solution to the alkali metal fluoride salt hydrogen fluoride solution in the reactor is as follows: a molar ratio of phosphorus contained in the phosphorus pentahalide inert solvent solution entering the reactor within unit time to alkali metal contained in the alkali metal fluoride salt hydrogen fluoride solution entering the reactor within unit time is 0.8-1.2:1;
in step (3), the reaction temperature is −40 to 100° C.;
(4) performing gas-liquid separation on the mixture consisting of hexafluorophosphate, hydrogen fluoride, the inert solvent and hydrogen halide obtained in step (3) to separate out a hydrogen halide gas, so as to obtain a mixture consisting of hexafluorophosphate, hydrogen fluoride and the inert solvent;
(5) removing hydrogen fluoride from the mixture consisting of hexafluorophosphate, hydrogen fluoride and the inert solvent obtained in step (4) to obtain a mixture consisting of hexafluorophosphate and the inert solvent; and
(6) performing solid-liquid separation on the mixture consisting of hexafluorophosphate and the inert solvent obtained in step (5), and then drying to obtain hexafluorophosphate.

2. The synthesis method of hexafluorophosphate according to claim 1, wherein the hexafluorophosphate is any one of lithium hexafluorophosphate, sodium hexafluorophosphate and potassium hexafluorophosphate.

3. The synthesis method of hexafluorophosphate according to claim 1, wherein in step (1), the phosphorus pentahalide is selected from one or two of phosphorus pentachloride and phosphorus pentabromide.

4. The synthesis method of hexafluorophosphate according to claim 1, wherein in step (1), the inert solvent is selected from one or more of:
alkane solvents selected from C4-C10 straight, branched or cyclic alkanes;
halogenated alkane solvents represented by the following general formula:
CₙH₍₂ₙ₊₂₋ₘ₎Xₘ
wherein X=F, Cl and Br, n=1-10, m=1-4, the carbon chain of halogenated alkane is straight, branched or cyclic;
aromatic solvents represented by the following general formula: Rₙ 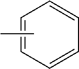
wherein substituent group R is H, or a C1-C6 straight, branched or cyclic alkyl substituent group, n=0-6, when multiple alkyl substituent groups are present in a phenyl ring, the alkyl substituent groups are the same or different;
halogenated aromatic solvents represented by the following general formula:
Rₙ Xₘ 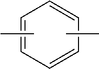
wherein substituent group R is H, or a C1-C6 straight, branched or cyclic alkyl substituent group, n=0-6, substituent group X=F, Cl and Br, m=0-6 and n+m≤6, when multiple alkyl and halogen atom substitutions are present in the phenyl ring, substituted alkyl and halogen atoms are the same or different.

5. The synthesis method of hexafluorophosphate according to claim 1, wherein in step (1), the amount of the inert solvent is as 1-20 times as the mass of phosphorus pentahalide.

6. The synthesis method of hexafluorophosphate according to claim 1, wherein in step (2), the alkali metal halide salt is represented by the following general formula:
MX
M=Li, Na and K
X=F, Cl and Br

7. The synthesis method of hexafluorophosphate according to claim 1, wherein in step (2), the amount of hydrogen fluoride is as 1-20 times as the mass of the alkali metal halide salt.

8. The synthesis method of hexafluorophosphate according to claim 1, wherein in step (2), the operation temperature for dissolving the alkali metal halide salt into anhydrous hydrogen fluoride to obtain the alkali metal fluoride salt hydrogen fluoride solution and the preservation temperature of the alkali metal fluoride salt hydrogen fluoride solution are −40 to 19° C.

9. The synthesis method of hexafluorophosphate according to claim 1, wherein when the synthesized product is lithium hexafluorophosphate, the alkali metal halide salt is selected from one or more of lithium fluoride, lithium chloride and lithium bromide; when the synthesized product is sodium hexafluorophosphate, the alkali metal halide salt is selected from one or more of sodium fluoride, sodium chloride and sodium bromide; when the synthesized product is potassium hexafluorophosphate, the alkali metal halide salt is selected from one or more of potassium fluoride, potassium chloride and potassium bromide.

10. The synthesis method of hexafluorophosphate according to claim 1, wherein in step (3), the reactor is a microreactor.

11. The synthesis method of hexafluorophosphate according to claim 1, wherein in step (3), the feeding ratio of the phosphorus pentahalide inert solvent solution to the alkali metal fluoride salt hydrogen fluoride solution in the reactor is as follows: the molar ratio of phosphorus contained in the phosphorus pentahalide inert solvent solution entering the reactor within unit time to alkali metal contained in the alkali metal fluoride salt hydrogen fluoride solution entering the reactor within unit time is 0.8-1.2:1.

12. The synthesis method of hexafluorophosphate according to claim 1, wherein in step (3), the reaction temperature is −40 to 100° C.

13. The synthesis method of hexafluorophosphate according to claim 1, wherein in step (4), the operation temperature for gas-liquid separation is −40 to 19° C.

14. The synthesis method of hexafluorophosphate according to claim 1, wherein in step (5), the operation temperature for removing hydrogen fluoride is 20-100° C.
